(19) United States
(12) Patent Application Publication
(10) Pub. No.: US 2018/0113219 A1
(43) Pub. Date: Apr. 26, 2018

(54) Method and system for ascertaining a position of a mobile apparatus

(71) Applicant: Geo++ GmbH, Garbsen (DE)

(72) Inventor: Gerhard WUEBBENA, Garbsen (DE)

(21) Appl. No.: 15/790,164

(22) Filed: Oct. 23, 2017

(30) Foreign Application Priority Data
Oct. 24, 2016 (DE) 10 2016 120 235.5

(51) Int. Cl. G01S 19/41; G01S 19/07

(52) U.S. Cl. CPC G01S 19/41; G01S 19/07

(57) ABSTRACT

The invention relates to a method for ascertaining a position of a first mobile apparatus, wherein a position finding device uses a GNSS to ascertain the position of the first mobile apparatus based on a propagation time measurement for GNSS signals of different GNSS satellites that are received by a GNSS receiver of the first mobile apparatus, characterized by
ascertainment of at least one piece of error information of the GNSS from the GNSS signals of different GNSS satellites that are received by a GNSS receiver provided on at least one second mobile apparatus at a reception position of the second mobile apparatus, by an error determination device,
transmission of the ascertained error information of the GNSS to the position finding device of the first mobile apparatus, and
ascertainment of the position of the first mobile apparatus by the position finding device taking into consideration the error information of the GNSS ascertained at the reception position of the at least one second mobile apparatus and transmitted to the position finding device.

The invention relates to a method and a system for ascertaining a position of a mobile apparatus, wherein a position finding device uses a GNSS to ascertain the position of the mobile apparatus based on a propagation time measurement for GNSS signals of different GNSS satellites that are received by a GNSS receiver of the first mobile apparatus.

The development of satellite navigation systems (GNSS: Global Navigation Satellite System), such as GPS, Galileo or Glonass, has led to the possibility of ascertaining the position of mobile apparatuses, such as vehicles, ships, aircraft or electronic hand-held devices, very accurately anywhere in the world. This is the first concept to allow applications such as automatic route navigation or autonomous driving, since reliable and accurate position finding for the vehicles is an essential basic prerequisite for such technologies.

In a satellite navigation system, a plurality of satellites are on a prescribed orbit around the earth and then continually transmit appropriate position signals (GNSS signals) that can be received by a signal receiver (GNSS receiver). The computation of the signal propagation time of the individual received GNSS signals can then be used to compute the distance from the GNSS receiver to the respective GNSS satellite, so that if there is a sufficient number of satellites (sufficient accuracy with four satellites) and the respective distance thereof from the GNSS receiver is computed and also the current position of the respective GNSS satellite on its orbit is known then it is possible to ascertain the position of the GNSS receiver by computing the point of intersection of the spheres around the respective satellite that are defined by the distance measurement.

The accuracy for the position finding is dependent particularly on two essential factors. First, satellite-conditional errors exist that have their origin in the satellite context itself. These are clock errors of the satellites, for example, or an orbit error of the satellite on its orbit, for example. On account of the fact that a propagation time measurement for the GNSS signals requires highly accurate synchronization of all the satellites and of the GNSS receiver, a discrepancy in a satellite clock can adversely influence accuracy. Second, signal-conditional errors, in particular, exist that have their origin in the passage of the signals through the spheres, such as the ionosphere, for example. As such, it is known, by way of example, that when a GNSS signal passes through the troposphere and ionosphere the propagation speed of the GNSS signal is influenced, which gives rise to an accuracy error for the propagation time computation based on a fixed value of the signal velocity.

To solve this problem of the inaccuracy of satellite navigation systems, what is known as a Differential Global Positioning System (DGPS) is known. The inaccuracies that arise in practice for a GNSS—based on a temporal and spatial variation in the signal velocities in the troposphere and ionosphere and based on the orbit and clock errors of the satellites—can be corrected thereby by virtue of these errors being ascertained using a fixed-location reference station. A fixed-location reference station of this kind is generally a GNSS receiver whose position on the earth is known with a high level of accuracy by virtue of other measurement methods. Based on a comparison between its own known position and the position ascertained using the GNSS, it is then possible to ascertain an appropriate error correction for the signal. The mobile apparatuses in the surrounding area of a fixed-location reference station of this kind can then receive an appropriate signal from the reference station that includes the respective correction value or the correction values so as to increase the accuracy of the GNSS, which has errors in the native implementation.

Since the correction becomes less accurate as the distance between the mobile apparatus or the GNSS receivers and the fixed-location reference station increases, it is possible to span longer distances by virtue of interpolation being effected between multiple reference stations.

The DGPS and the fixed-location reference stations can admittedly be used to reliably correct what are known as the global error components of a GNSS, that is to say those errors that have no spatial and temporal variance, during position finding. The local error components, that is to say those GNSS errors that have a spatial and temporal variance, can be corrected conditionally in this case only using the fixed-location reference stations, the accuracy of the error correction decreasing as the distance from the reference station increases. Since the number of fixed-location reference stations is severely limited, the distance between the individual reference stations is relatively great, which means that an interpolation between the reference stations can map the spatially and temporally varying errors only very conditionally.

It is therefore an object of the present invention to specify an improved method and an improved system that can be used to significantly improve the accuracy for the ascertainment of a position of a mobile apparatus particularly in respect of the spatially and temporally varying errors.

The object is achieved according to the invention by the method according to claim 1 and the system according to claim 8.

Claim 1 proposes a method for ascertaining a position of a first mobile apparatus, wherein a position finding device uses a GNSS to ascertain the position of the first mobile apparatus based on a propagation time measurement for GNSS signals of different GNSS satellites that are received by a GNSS receiver of the first mobile apparatus. The first mobile apparatus is accordingly that mobile apparatus whose position is intended to be ascertained. To receive the GNSS signals of the GNSS satellites, the GNSS receiver is arranged on or in the mobile apparatus and provided at that point and has an appropriate antenna if need be. In this case, the position finding device connected to the GNSS receiver for signaling purposes is preferably likewise arranged on or in the mobile apparatus and provided at that point. Within the context of a centralized system, however, it is also conceivable for the position finding device not to be part of the mobile apparatus, so that the GNSS signals received by the GNSS receiver have to be transmitted to the position finding device by signaling first of all. Normally, the position finding device will be part of the mobile apparatus, however.

A mobile apparatus in this case may particularly be a road vehicle, such as automobiles or trucks. It is also conceivable for the mobile apparatus to be a ship or watercraft or an aircraft. Furthermore, it is also conceivable for the mobile apparatus to be an electronic terminal, such as a laptop or tablet, for example, or a mobile radio terminal, for example a smartphone.

The position finding device is in this case configured such that it takes the GNSS signals received by the GNSS receiver as a basis for computing and ascertaining the position of the mobile apparatus. The computation of the positions on the basis of the received GNSS signals is in this case effected in accordance with the manner of operation of a satellite navigation system based on propagation time differences of the received GNSS signals. The ascertained position in this case either natively relates to the specific reception location, i.e. the antenna or the GNSS receiver, or has been normalized to a reference point of the mobile apparatus on the basis of the fixed installation position of the antenna or of the GNSS receiver in relation to the mobile apparatus. In this respect, the position of the mobile apparatus in the case of larger apparatuses, such as vehicles, for example, means a particular reference point in relation to the mobile apparatus.

According to the invention, there is now provision for a piece of error information of the GNSS to be ascertained from the GNSS signals of different GNSS satellites that are received by a GNSS receiver provided on at least one second mobile apparatus at a reception position of the second mobile apparatus, by an error determination device.

The ascertainment of at least one piece of error information of the GNSS that contains an accuracy error of the GNSS is in this case effected particularly for the spatially and temporally varying accuracy errors, as are conditional upon the troposphere and ionosphere, for example.

In this case, the second mobile apparatus likewise has a GNSS receiver in order to be able to receive the GNSS signals of the GNSS satellites and forward them to the error determination device. The error determination device may in this case likewise be provided on or in the mobile apparatus and be part of said mobile apparatus, so that an error determination device is provided for each mobile apparatus and the error determination is therefore performed locally by each mobile apparatus itself. However, it is also conceivable for a central error determination device to be provided for all the mobile apparatuses, the mobile apparatuses then being in a form such that the GNSS signals received by the GNSS receiver, or the properties derived therefrom for the signals, are transmitted to the central error determination device and evaluated therein. The ascertainment of a piece of error information by the error determination device is therefore based on the received GNSS signals of the different GNSS satellites that are received by a mobile apparatus. As result, it becomes possible, at the reception position of the second mobile apparatus, i.e. that current position that was present at the time at which the GNSS signals were received by the GNSS receiver of the mobile apparatus, the appropriate error information can then be ascertained, so that the appropriate reception position can be attributed the error information ascertained at this reception position.

In this case, it is conceivable for the error determination device to be part of a position finding device of the second mobile apparatus, since the second mobile apparatus may also be configured to ascertain the position using a GNSS. In this case, it is also conceivable for the first mobile apparatus to have not only the position finding device but also an error determination device. The role of the first and second mobile apparatuses is then selectively interchangeable.

The error information of the GNSS as ascertained at the reception position of the second mobile apparatus is now transmitted to the position finding device of the first mobile apparatus, so that the position finding device of the first mobile apparatus has a piece of error information of the GNSS available for ascertaining the positions of the first mobile apparatus. The position finding device of the first mobile apparatus is now configured such that it ascertains the position of the first mobile apparatus taking into consideration the error information of the GNSS that is ascertained at the reception position of the at least one second mobile apparatus and transmitted to the position finding device, so that the position finding device of the first mobile apparatus has particularly at least spatially and temporally varying error information available, which can significantly improve the error correction for locally bounded errors of this kind.

If there exists a multiplicity of second mobile apparatuses that all ascertain at least one piece of error information of the GNSS at their respective reception positions, then this allows a very good image of the spatially and temporally varying errors to be ascertained, as result of which the probability of a first mobile apparatus that wants to ascertain its position being in proximity to a reception position of a second mobile apparatus at which a piece of error information of the GNSS has been ascertained, so that the spatially and temporally varying errors or propagation time errors of the GNSS signals can be corrected much better and more accurately. The second mobile apparatuses are accordingly used in the manner of a fixed-location reference station, the error determination device for the individual mobile apparatuses at the respective reception position being able to be used to ascertain a piece of error information of the GNSS from the received GNSS signals.

Advantageously, the ascertainment of the at least one piece of error information is performed by means of the second mobile apparatus in the moving or unmoving state of the second mobile apparatus.

In one advantageous embodiment, a plurality of a second mobile apparatuses are provided at whose respective reception positions at least one piece of error information of the GNSS is ascertained, wherein the error information of the GNSS ascertained at the respective reception position of the second mobile apparatus is transmitted to the position finding device of the first mobile apparatus and the position of the first mobile apparatus is ascertained by the position finding device taking into consideration this error information of the GNSS ascertained at the different reception positions of the second mobile apparatus. In this case, it is conceivable for the position finding device of the first mobile apparatus to ascertain the own position of the first mobile apparatus taking into consideration all the ascertained error information of the GNSS that is transmitted in this case.

However, it is also conceivable for only that error information whose respective reception position is within a prescribed radius or within a prescribed surrounding area to be taken into consideration for the ascertainment of the position of the first mobile apparatus, so that only error information that has a close spatial relationship with own position is used for the ascertainment of own position.

However, it is also conceivable for the error information, when taken into consideration, to be weighted on the basis of a distance of the first mobile apparatus from the respective reception position of the respective error information, so that particularly error information with a reception position very close to the first mobile apparatus is weighted more highly and therefore has a greater influence on the ascertainment of the position than error information with a reception position that is much further away from the position of the first mobile apparatus.

In a further advantageous embodiment, it is also conceivable for only that error information whose respective reception position is within a prescribed surrounding area or within a prescribed radius in relation to the first mobile apparatus to be transmitted to the position finding device of the first mobile apparatus. Therefore, it is not the area information of all the second mobile apparatuses that is transmitted but rather only that error information whose respective reception position is relevant to the ascertainment of the position of the first mobile apparatus. This allows the amount of data to be transmitted to be scaled better.

In a further advantageous embodiment, error information of the GNSS that has been ascertained by means of at least one fixed-location reference station is transmitted to the position finding device of the first mobile apparatus, wherein the position of the first mobile apparatus is then ascertained by the position finding device taking into consideration the error information of the GNSS that is ascertained using the second mobile apparatus and taking into consideration the error information of the GNSS that is ascertained by means of the fixed-location reference station (EN).

This allows global error components of the GNSS to be obtained from the fixed-location reference stations directly, whereas the spatially and temporally varying errors come from the error information of the second mobile apparatuses. Hence, for the correction ascertainment of the position of the first mobile apparatus by means of the GNSS, the case arises that the correction information is based on two different data sources, namely first on fixed-location reference stations and second on mobile apparatuses, on the other hand. Without significantly increasing the number of fixed-location reference stations, it is therefore possible to achieve the accuracy of a DGPS using a known GNSS.

Accordingly, it is quite particularly advantageous if one or more pieces of position-independent error information of the GNSS that characterize an accuracy error of the GNSS independently of a reception position and that have been ascertained by means of at least one fixed-location reference station are transmitted to the position finding device of the first mobile apparatus and wherein a piece of position-dependent error information of the GNSS that characterizes an accuracy error of the GNSS depending on a reception position (spatially and/or temporally) and has been ascertained by means of the at least one second mobile apparatus is transmitted to the position finding device of the first mobile apparatus, the position of the first mobile apparatus being ascertained by the position finding device taking into consideration the position-independent error information of the GNSS and the position-dependent error information of the GNSS.

In a further advantageous embodiment, one or more pieces of position-independent error information of the GNSS that characterize an accuracy error of the GNSS independently of a reception position and that have been ascertained by means of at least one fixed-location reference station are transmitted to the error determination device of the second mobile apparatus, wherein a piece of position-dependent error information of the GNSS that characterizes an accuracy error of the GNSS depending on a reception position is ascertained by the error determination device at the reception position of the at least one second mobile apparatus from the GNSS signals of different GNSS satellites that are received by the GNSS receiver of the at least one second mobile apparatus at the reception position of the second mobile apparatus, taking into consideration the position-independent error information of the at least one reference station.

In the light of the position-independent error information, i.e. the global error components of the total error of the GNSS, the errors that remain are the spatially and temporally varying errors that are conditional particularly on the influencing of the signal propagation time in the troposphere and ionosphere. As such, it is conceivable, by way of example, that the GNSS signals of the satellites are received over a longer period using the error determination device, wherein an adequate number of GNSS signals and the accompanying position finding of the second mobile apparatus then allow a measure of the propagation time error to be derived that can then be defined as a piece of position-dependent error information at the reception position of the second mobile apparatus.

A suitable piece of position-independent error information of the GNSS is particularly a clock error of a GNSS satellite, an orbit error of a GNSS satellite, a signal bias and/or global atmospherically conditional errors. In this case, the position-dependent error information may be a local, atmospherically conditional error that is conditional particularly upon the troposphere and/or ionosphere.

The invention is explained in more detail by way of example with reference to the appended figures, in which:

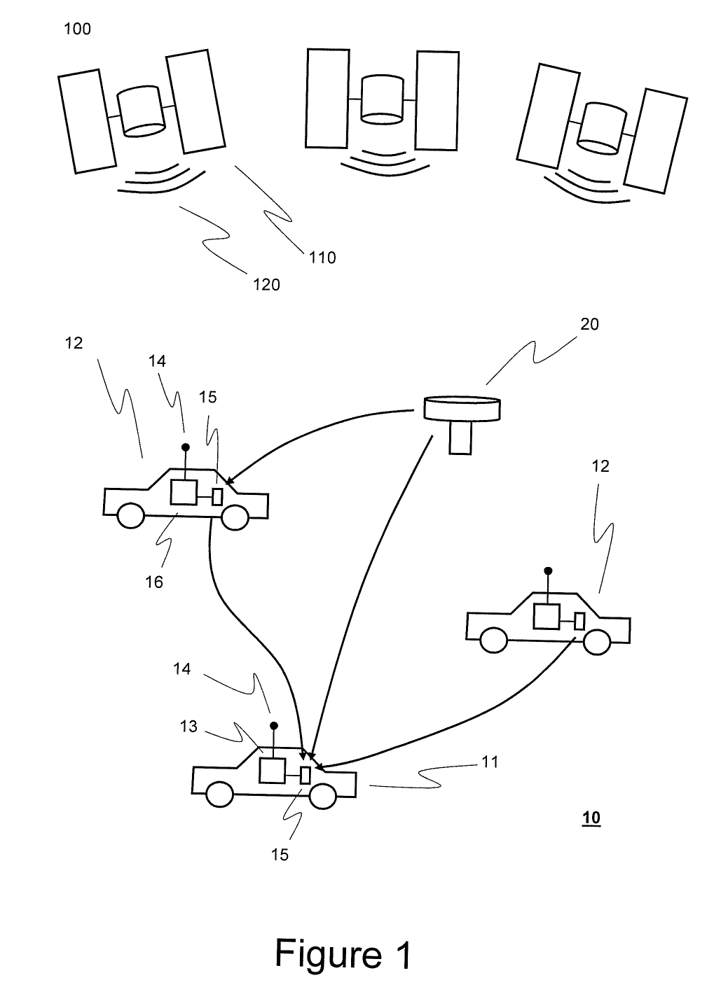

FIG. 1 shows a schematic depiction of the system in a local embodiment;

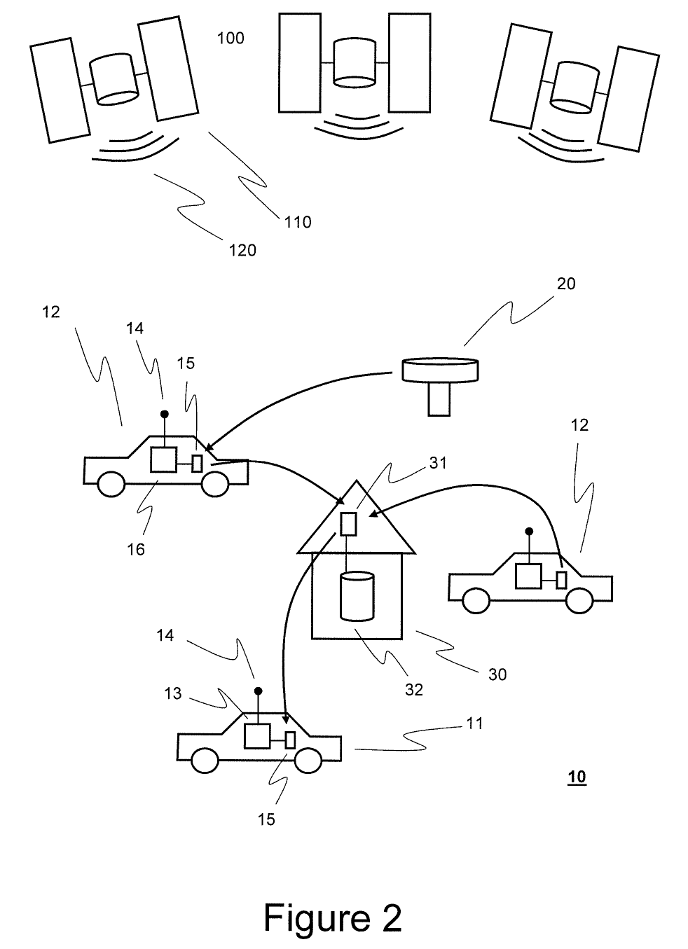

FIG. 2 shows a schematic depiction of the system according to the invention in a central embodiment;

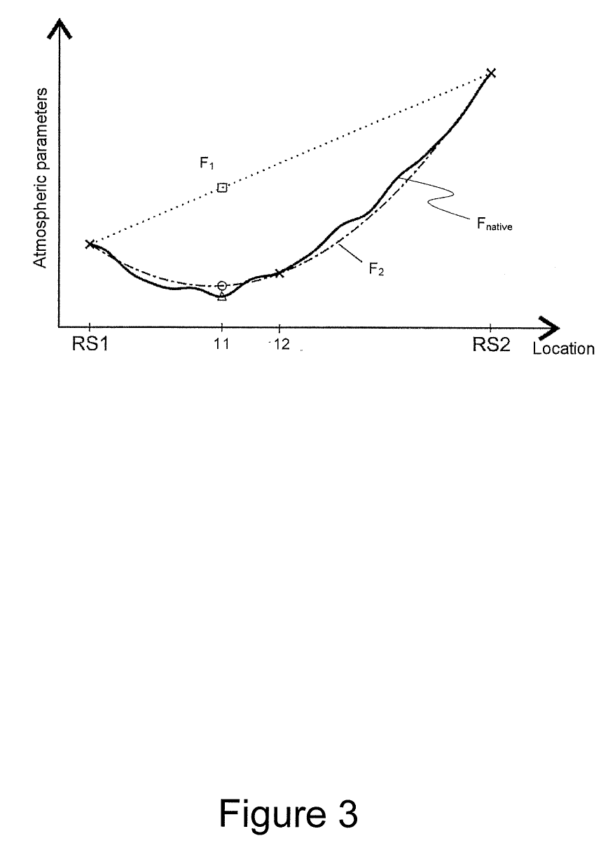

FIG. 3 shows a graph relating to the operating principle of the present method according to the invention.

FIG. 1 shows the system 10 according to the invention for ascertaining a position of a first mobile apparatus 11 using a satellite navigation system 100 that consists of a plurality of satellites 110 that are configured to transmit GNSS signals 120, on the basis of which the position of the first mobile apparatus 11 is then supposed to be ascertained. The satellite navigation system 100 with its satellites is not part of the system 10 in this case, but rather is merely the basis on which the system 10 is formed.

In the exemplary embodiment of FIG. 1, the mobile apparatuses are motor vehicles whose position is supposed to be ascertained with high accuracy. To this end, the first mobile apparatus 11 has a position finding device 13 that has a connection to a GNSS receiver 14. The GNSS receiver 14 furthermore has an antenna that can be used to receive the GNSS signals 120 of the satellites 110 at the mobile apparatus 11.

Based on the GNSS signals 120 received by the GNSS receiver 14 of the first mobile apparatus 11, the position finding device 13 of the first mobile apparatus 11 can ascertain the position of the first mobile apparatus 11 in relation to a reference point of the first mobile apparatus 11. To this end, the propagation time of the individual signals 120 of the satellites 110 is ascertained and hence the position is determined. This can be effected using hyperbolic navigation, for example.

Moreover, in a first mobile apparatus 11, the system 10 has a communication module 15 that is configured to communicate with other communication modules of other apparatuses or stations, as explained below.

Moreover, in the exemplary embodiment of FIG. 1, two further second mobile apparatuses 12 are provided that are identical in terms of the basic functionality. Each of the mobile apparatuses 12, which are likewise a vehicle, have an error determination device 16 that has a signaling connection to a GNSS receiver 14 arranged on the second mobile apparatuses 12. The second apparatuses 12 also have a communication module 15 that has a signaling connection to the error determination device 16 and is used for interchanging data with other apparatuses.

In this case, the error determination device 16 of the second mobile apparatus 12 is configured such that it ascertains a piece of error information of the GNSS 100 at the reception position of the respective second mobile apparatus 12 on the basis of the GNSS signals 120 received by the respective GNSS receiver 14. In this case, this error information of the GNSS 100 can include not only the global error components (orbit errors, clock errors) but also atmospherically conditionally error information, which varies spatially and temporally. For the respective reception position of the second mobile apparatus 12, it is therefore possible to ascertain a piece of error information of the GNSS 100 that is locally based on a reception position and that then also contains the spatially and temporally varying error components. Hence, it is quite particularly advantageous if any error information that is ascertained by a second mobile apparatus 12 is related to the reception position and reception time.

The ascertainment of a piece of error information based on the reception of GNSS signals can be effected in this case by the reception of more than the satellite that is needed here. Measurements by means of GNSS are for the most part overdefined, i.e. many more than the four required satellites are received. As a result, beyond the pure position and receiver clock, it is also possible for further state variables to be ascertained that, by way of example, the spatially and temporally varying, atmospherically conditional error components. Input variables for the computation may in this case be pseudo ranges and phase measurements for the individual (more than four) satellites and the received signals thereof. Output variables would be the three dimensional coordinates (X, Y, Z), the receiver clock error (Δ_{T}) and a set of atmospheric correction parameters. The receiver clock error and a set of atmospheric correction parameters are each a piece of error information of the GNSS within the context of the present invention. In this case, both the position and the atmosphere are computed in one step/at one time from a multiplicity of erroneous measurements for the individual satellites.

To increase the accuracy for the ascertainment of the GNSS error, it is conceivable for the error determination unit 16 of the second mobile apparatuses 12 to receive via the communication module 15 appropriate error information of a fixed-location reference station 20, from which it is possible to extract the global, i.e. position-independent, error components of the GNSS error. This allows the error determination for spatially and temporally varying errors to be improved, specifically in terms of accuracy and computation speed, since it is now possible to obtain a convergence much earlier. The error information of the GNSS that is ascertained by the error determination devices 16 of the second mobile apparatuses 12 is now transmitted to the first mobile apparatus 11 using the communication modules 15 and received by the communication module 15 at said first mobile apparatus. Based on the received error information, the position finding device 13 is configured to take into consideration this error information in order to ascertain the position of the first mobile apparatus 11 based on the GNSS 100 and in so doing to accordingly compensate for the GNSS error by means of an appropriate correction based on the transmitted error information. There is therefore no longer any need for further fixed reference stations, but rather moving mobile apparatuses suffice in order to increase the accuracy regarding the spatially and temporally varying errors of the GNSS.

In this case, it is likewise conceivable for the first mobile apparatus also to use its communication module 15 to obtain appropriate error information of the fixed-location reference station 20, as result of which the position finding per se can be improved. This is advantageous particularly if the second mobile apparatuses merely transmit the local error components, i.e. the atmospherically conditional error components of the GNSS error. In this case, it is then possible for the fixed-location reference station 20 to ascertain the global error components.

In a second embodiment, which is depicted in FIG. 2, the individual second mobile apparatuses 12 transmit their ascertained error information not directly to the first mobile apparatus 11 but rather to a control center 30. To this end, the control center 30 has a communication module 31 in order to communicate with the mobile apparatuses. The error information ascertained and transmitted by the second mobile apparatuses 12 is then received by the communication module 31 of the control center 30 and stored in a digital data memory 32. Advantageously, the error information is associated with the reception position and with the ascertainment time in this case, so that an appropriate piece of error information is characterized both spatially and temporally. A vehicle, i.e. the first mobile apparatus 11, that now wishes to ascertain its position is now provided with the error information from the data memory 32, specifically regarding its current position, at its appropriate current position. This information is ascertained coarsely beforehand and then serves as a guideline. On the basis of the coarsely ascertained own position of the first apparatus 11, all the error information that is within a prescribed radius or a prescribed surrounding area is then read from the digital data memory 32 and transmitted to the communication module 15 of the first mobile apparatus 11.

The position finding device 13 of the first mobile apparatus is now configured such that it ascertains its own position based on the GNSS signals 120 and taking into consideration the transmitting error information. In this case, it is conceivable for interpolation to be effected between the individual pieces of error information of the different second mobile apparatuses and if need be a reference station, since normally the first mobile apparatus is not exactly at one of the reception positions of the second mobile apparatuses 12. Normally, the first mobile apparatus will move, so that in this case the pieces of error information provided need to be continually evaluated and to have interpolation effected between them.

An example is shown in this case by FIG. 3 in the form of a graph. The Y axis in this case has an atmospherically conditionally error component plotted on it by way of example, while the reception location is defined on the X axis. At the two outer location positions RS1 and RS2, there is a respective reference station RS1 and RS2, which delivers an appropriate piece of error information in highly accurate fashion. However, the atmospherically conditional error component changes between the reference stations RS1 and RS2, since the two reference stations are spatially very far apart.

The first mobile apparatus 11 now wishes to ascertain its own position and in so doing take into consideration appropriate error information of the GNSS. If just the atmospherically conditional error components of the reference station in the RS1 and RS1 were available in the first mobile apparatus 11, then it would need to interpolate between said reference stations regarding the spatial distance between the two reference stations, which would lead to an atmospherically conditional error component F1. This error component is obtained from a purely linear, for example, interpolation between the two reference stations RS1 and RS2.

The actual profile of the atmospherically conditional error component, which is shown in FIG. 3 as a curve Fₙₐₜᵢᵥₑ, greatly differs from the interpolated error profile, however, which means that a not inconsiderable inaccuracy would arise during the ascertainment of own position by the first mobile apparatus 11.

Between the reference stations 1 and 2, there is moreover a second mobile apparatus 12 that has used its error determination device to ascertain a piece of error information regarding the spatially and temporally varying errors of the GNSS. This atmospherically conditional error component or the error information based thereon is now transmitted by the second mobile apparatus 12 to the first mobile apparatus 11, which wants to ascertain its position.

In the light of the error information of the two reference stations RS1 and RS2, and in the light of the error information ascertained by the second mobile apparatus 12, it is now possible to interpolate the actual profile of the spatially and temporally bounded errors much more accurately between the two reference stations RS1 and RS2, as depicted by the interpolated curve F₂. As can be seen, the atmospherically conditional error component at the position of the first mobile apparatus 11 differs from the interpolated profile F₂ much less than from the interpolated profile F₁ in this case, so that a much higher level of accuracy is obtained for the position finding in this case.

1. A method for ascertaining a position of a first mobile apparatus, comprising:
using a Global Navigation Satellite System (GNSS) to ascertain a position of the first mobile apparatus based on a propagation time measurement for GNSS signals of different GNSS satellites that are received by a GNSS receiver of the first mobile apparatus;
ascertaining of at least one piece of error information of the GNSS from the GNSS signals of the different GNSS satellites that are received by a second GNSS receiver provided on at least one second mobile apparatus at a reception position of the at least one second mobile apparatus, by an error determination device;
transmitting the at least one piece of error information of the GNSS ascertained in the first ascertaining step to a position finding device of the first mobile apparatus; and
ascertaining a position of the first mobile apparatus by the position finding device of the first mobile apparatus taking into consideration the at least one piece of error information of the GNSS ascertained at the reception position of the at least one second mobile apparatus and transmitted to the position finding device of the first mobile apparatus.

2. The method according to claim 1, wherein the at least one second mobile apparatus includes plurality of a second mobile apparatuses, and the plurality of second mobile apparatuses have respective reception positions for the at least one piece of error information of the GNSS, wherein the at least one piece of error information of the GNSS ascertained at the respective reception positions of the plurality of second mobile apparatuses is transmitted to the position finding device of the first mobile apparatus, and the position of the first mobile apparatus is ascertained by the position finding device of the first mobile apparatus taking into consideration at least some error information of the GNSS ascertained at the different reception positions of the plurality of second mobile apparatuses.

3. The method according to claim 1, wherein the at least one second mobile apparatus includes plurality of second mobile apparatuses, and the plurality of second mobile apparatuses have respective reception positions for the at least one piece of error information of the GNSS, wherein only error information of reception positions of one or more second mobile apparatuses of the plurality of second mobile apparatuses that are within a prescribed surrounding area of the first mobile apparatus are taken into consideration by the position finding device of the first mobile apparatus when ascertaining the position of the first mobile apparatus.

4. The method according to claim 1, wherein the at least one piece of error information of the GNSS is ascertained by at least one fixed-location reference station and is transmitted to the position finding device of the first mobile apparatus, wherein the position of the first mobile apparatus is ascertained by the position finding device taking into consideration the at least one piece of error information of the GNSS ascertained at the reception position of the at least one second mobile apparatus and the at least one piece of error information of the GNSS ascertained by of the at least one fixed-location reference station.

5. The method of claim 1, wherein one or more pieces of position-independent error information of the GNSS that characterize an accuracy error of the GNSS independently of a reception position are ascertained by at least one fixed-location reference station and are transmitted to the error determination device of the second mobile apparatus, wherein at least one a piece of position-dependent error information of the one or more pieces of position-dependent error information of the GNSS that characterizes an accuracy error of the GNSS depending on a reception position is ascertained by the error determination device at the reception position of the at least one second mobile apparatus from the GNSS signals of different GNSS satellites that are received by the GNSS receiver of the at least one second mobile apparatus at the reception position of the second mobile apparatus, wherein the error determination device takes into consideration position-independent error information of a reference station.

6. The method according to claim 5, wherein the position-independent error information is transmitted to the error determination device provided on the at least one second mobile apparatus.

7. The method according to claim 5, wherein the position-independent error information is selected from the group consisting of a clock error of a GNSS satellite, an orbit error of a GNSS satellite, a signal bias error, and a global atmospherically conditional error, and wherein the position-dependent error information is a local, atmospherically conditional error.

8. A system for ascertaining a position of a first mobile apparatus, comprising:
a position finding device that is configured to ascertain the position of the first mobile apparatus based on a propagation time measurement for Global Navigation Satellite System (GNSS) signals of different GNSS satellites that are received by a GNSS receiver of the first mobile apparatus;
at least one error determination device is provided that is set up to ascertain at least one piece of error information of the GNSS from the GNSS signals of different GNSS satellites that have been received by a GNSS receiver provided on at least one second mobile apparatus at a reception position of the second mobile apparatus,
wherein the system is set up to transmit the ascertained error information of the GNSS to a position finding device of the first mobile apparatus,
wherein the position finding device of the first mobile apparatus is configured to ascertain the position of the first mobile apparatus taking into consideration the at least one piece of error information of the GNSS ascertained at the reception position of the at least one second mobile apparatus and transmitted to the position finding device of the first mobile apparatus.

9. The system according to claim 8, wherein the at least one second mobile apparatus includes a plurality of second mobile apparatuses, and the plurality of second mobile apparatuses each have a respective error determination devices that are configured to ascertain the at least one piece of error information of the GNSS at the reception position of the respective second mobile apparatus, wherein the system is set up to transmit the ascertained at least one piece of error information of the respective second mobile apparatuses to the position finding device of the first mobile apparatus, and wherein the position finding device of the first mobile apparatus is configured to ascertain the position of the first mobile apparatus taking into consideration the at least one piece of error information of the GNSS ascertained at the respective reception positions of the second mobile apparatuses which are transmitted to the position finding device of the first mobile apparatus.

10. The system according to claim 9, wherein the system is configured to transmit only the at least one piece of error information of those reception positions of one or more the second mobile apparatuses of the plurality of second mobile apparatuses that are within a prescribed surrounding area of the first mobile apparatus to the position finding device of the first mobile apparatus.

11. The system according to claim 9, wherein the position-finding device of the first mobile apparatus is configured to take into consideration only the at least one piece of error information obtained from reception positions of the one or more second mobile apparatuses of the plurality of second mobile apparatuses that are within a prescribed surrounding area of the first mobile apparatus when ascertaining the position of the first mobile apparatus.

12. The system according to claim 8, wherein the position finding device of the first mobile apparatus is configured to receive at least one piece of error information of the GNSS ascertained by at least one fixed-location reference station, and wherein the position finding device of the first mobile apparatus is set up to ascertain the position of the first mobile apparatus taking into consideration the at least one piece of error information of the GNSS ascertained at the reception position of the at least one second mobile apparatus and the at least one piece of error information of the GNSS ascertained by the at least one fixed-location reference station.

13. The system according to claim 8, wherein the at least one error determination device is configured to receive one or more pieces of position-independent error information of the GNSS that characterize an accuracy error of the GNSS independently of a reception position and that have been ascertained by at least one fixed-location reference station, and wherein the at least one error determination device is set up to ascertain a piece of position-dependent error information of the GNSS that characterizes an accuracy error of the GNSS depending on a reception position at the reception position of the at least one second mobile apparatus from the GNSS signals of different GNSS satellites that are received by the GNSS receiver of the at least one second mobile apparatus at the reception position of the second mobile apparatus, wherein the at least one error determination device takes into consideration the position-independent error information.

14. The system according to claim 13, wherein the position-independent error information is selected from a clock error of a GNSS satellite, an orbit error of a GNSS satellite, a signal bias error, and a global atmospherically conditional error, and wherein the position-dependent error information is a local, atmospherically conditional error.

15. The system of according to claim 14 wherein the local, atmospherically conditional error is conditional upon the ionosphere.

16. The method according to claim 7 wherein the local, atmospherically conditional error is conditional upon the ionosphere.
